(19) United States
(12) Patent Application Publication
(10) Pub. No.: US 2019/0299036 A1
(43) Pub. Date: Oct. 3, 2019

(54) SECURITY FALL PROTECTION DEVICE

(71) Applicant: BIEFFEPI S.R.L., CALENZANO (IT)

(72) Inventors: Stefano BARACCO, Firenze (IT); Marco PESCIONI, Pistoia (IT); Roberto CALAMAI, Pistoia (IT)

(21) Appl. No.: 16/303,193

(22) PCT Filed: May 23, 2017
(86) PCT No.: PCT/IB2017/000627

§ 371 Date: Nov. 20, 2018

(30) Foreign Application Priority Data
May 23, 2016 (IT) 102016000052435

(51) Int. Cl. A62B 35/00; A62B 35/04

(52) U.S. Cl. CPC A62B 35/0068; A62B 35/0056; A62B 35/04

(57) ABSTRACT

A safety device is provided having a base positionable on the ground; a supporting structure configured to swivelling support an arm rotatable about a rotational axis; a rotational stopping means having elements connected respectively to the arm and to the supporting structure configured to cooperate each other to interrupt the rotation of the arm about the rotational axis when the intensity of a component lying on a plane passing through the rotational axis of a force applied to an anchoring point of the arm exceeds a predetermined threshold.

### CROSS REFERENCE TO RELATED APPLICATION

This application claims the benefit of PCT application No. PCT/IB2017/000627, filed May 23, 2017, which claims the benefit of Italian application No. 102016000052435 filed May 23, 2016, the entire contents of each which are incorporated by reference herein for all purposes.

### TECHNICAL FIELD

The present invention relates to a security device, specifically to a device for saving life of a user in case of accidental fall from a workplace at height, even more specifically to a security fall protection device for means of transportation.

### STATE OF THE ART

In the state of the art exists several solutions for avoiding the fall of a user from a predetermined workplace at height.

In particular, these solutions are thought for workers which operate between 2 and 10 meters from the ground.

In this range of heights are included the activities performed on the fuselage or wings of the airplane, on the helicopters, on the roofs of trains, trucks and busses.

Scaffolds, like those for construction purposes, are known in the art for realizing fix structures able to facilitate the ascent and descent of a user from and to the workplace at height. These solutions are not transportable and are not able to be adapted to various operating contexts, on the contrary they are constructed and fitted to the specific activities to be performed.

In the state of the art also exists a solution conceived for maintenance activities on the airplanes which comprises a mobile base, an extendable ladder and a landing platform for accessing to a workplace at height. An example is the well-known product named “free-standing horizontal rail system” of the company Flexible Lifeline Systems. Differently from the scaffolds, this solution is movable and allows to adapt the height of the device, but it does not allow to a user to move safe on a wide workplace at height.

A further known solution is the product named WinGrip of the company Latchways which allows through suction cups to fix security cables to the workplace at height, for example to the wing of an airplane. By means of further cables anchored to the security cables, the user can work safe on the workplace at height.

This system has a main inconvenient associated to the positioning of the sustaining elements of the security cables. During the positioning phase of the sustaining elements the user has not security lock points and risks to fall. To solve this problem, the user needs to use a crane or ladder, for positioning the sustaining elements of the security cables and only after can operate safe.

Furthermore, this solution works only if the surface for fixing the sustaining elements is perfectly smooth, otherwise the elements cannot adhere.

Finally, this solution does not allow the user to operate on a wide area, because he is obliged to follow a predetermined path associated to the positioning of the security cable and the sustaining elements.

A further type of kwon fall protection devices is represented by a crane provided with a counterweight which, by means of a system of pulleys, allows the user to reach the workplace at height and successively to operate in this area. An example of this type of devices is sold by the company DBI-SALA with the commercial name “Flexiguard® Counterweight Rail Fas”.

A further type of fall arrest system is provided with the patent application EP3002044 wherein a portion of a mast to which is connected a rotating arm may deform in a plastic manner to absorb an eventual fall of a user connected to the arm. This system does not guarantee the safety of the user, because it does not interrupt the rotation of the mast in case of fall. Furthermore, this system is not reversible, that means that once the mast deforms due to the fall of the user, the system itself is not reusable if the deformed mast is not substituted. This kind of devices is not transportable or transferrable, furthermore, as long as the user has not reach the workplace area, he is suspended in the air and, in case of windy days, he is exposed to potential impacts with fix structures.

The devices known in the state of the art do not solve several problems, in particular they do not provide a device:
operable by a single user;
demountable and easy to be reassembled;
adaptable to any workplace at height;
economic;
movable;
with modular operating height and depth;
which maximises the work area at height wherein the user can operate;
which simplifies the ascent and descent;
which is safe in every instant for the user;
which allows to avoid a fall to the ground of the user from the workplace at height;
which does not need an electric supply;
which safeguards the life of a user in any type of fall.

### SUMMARY

The present invention has the scope of solving the above-mentioned disadvantages of the state of the art.

These disadvantages are overcome by a safety device comprising:
a base able of being positioned on the ground;
a supporting structure configured to swivelling support an arm rotatable about a rotational axis;
rotational stopping means comprising elements connected respectively to the arm and to the supporting structure, configured to cooperate each other to interrupt the rotation of the arm about the rotational axis when the intensity of a component lying on a plane passing through the rotational axis of a force applied to an anchoring point of the arm exceeds a predetermined threshold.

Advantageously, being the rotary arm swivelling connected to the base anchored to the ground, it allows to enlarge the area wherein the user can operate when he is at a predetermined height from the ground, thus on the workplace at height.

Even more advantageously, in case of accidental fall of the user from the workplace at a height, the rotating stopping means allows to block the rotation of the arm with respect to the rest of the device, thereby making the fall arrest device monolithic. The fact that the fall arrest device is monolithic means that the arm is connected firmly to the rest of the structure, but in reversible manner.

In these circumstances, the fell user is firmly attached to a structure which, being monolithically positioned on the ground, unloads the fall forces to the ground. Furthermore, being the arm stopped, the user is protected by falls on the ground or collisions with other objects.

In the present invention, the terms “user”, “operator”, “worker” or “human are used as synonyms and used to indicate a person that is using the fall protection device.

The base of the device can further comprise blocking means configured to stop the base to the ground.

Advantageously, these blocking means allow to reversibly block the base to the ground, so that all forces unload on the ground without a movement of the base during the eventual fall of the user from the workplace at a height.

According to this invention the term “workplace at height” or “work area at a height” means an area that is elevated with respect to the ground of at least 2 meters. In the same way, the term “at height” or “at a height” means a distance from the ground of at least 2 meters. For this reason, the plane on which the arm rotates is placed at least 2 meters from the ground, preferably at least 4 meters. Said plane is substantially parallel to the ground, thus horizontal or inclined of +/−5° with respect to an horizontal plane.

On this plane can be arranged the anchoring point to which the user is connected by means of a security lanyard. That plane is preferably arranged over the user head for avoiding impacts with him.

The device can comprise landing platform or a landing man-basket arranged at a predetermined height from the ground for allowing the user to easily reach the workplace at height.

Said platform allows to facilitate the access of the user to the workplace at height. This device further comprises an anchoring point arranged on the arm and connected to its end which is far from the rotational axis. The anchoring point is firmly connected to the arm. To the anchoring point can be connected the security lanyard, which is also connected to the harness of the user.

Being the anchoring point arranged at a maximum distance from the rotational axis and being the arm rotatable, the user is free to safely move in an extremely wide work area with respect to the commonly known safety devices.

Once the user is connected through the security lanyard, or eventual alternative means, to the anchoring point, the user is safe even in case of fall from that height. Furthermore, since the arm follows the user in each movement, the position of the anchoring point is always optimized, in case of fall, with respect to the user position.

Indeed, when the user uses the device, working on the workplace at height, the arm is completely free to rotate with respect to the supporting structure and it easily rotates with the sole force applied by the user to the anchoring point by means of the security lanyard, without any motor, spring or pistons.

The user is thus free to move in the work area at a height, pulling in rotation the arm by means of the security lanyard.

While, if the user accidentally falls from the work area at height, the energy generated by the mass of the human unloads on the anchoring point, exercising on the same a force which implies the stop of the arm. The user remains thus hanged to the device without impacting the floor or other obstacles.

Said force applied to the anchoring point of the arm can be vertical, horizontal or oblique with respect to the ground.

The value of the component lying on the plane passing through the rotational axis of the arm, which determines the trigger of the braking system, is less than 500 N, preferably less than 300 N.

The force applied to the anchoring point is the force generated by the fall of a human from a workplace at height. Said force triggers the rotational stopping means, making the device rigid and safeguarding the user at maximum level.

The device can further comprise a stair for allowing the ascent of the user and for reaching the work area at height, preferably by means of a landing step.

The safety device is configured so that it can operate between a rest position and an operative position. In said rest position, the arm is free to rotate on a plane substantially parallel to the ground. In the operative position, the arm is blocked, or braked, with respect to the rest of the supporting structure.

Said rotational stopping means or braking system comprises elements connected respectively to the arm and to the supporting structure. Said element connected to the supporting structure can be a braking element. Said element connected to the arm can be a portion of the arm itself. When the arm is in said operative position, said portion of the arm cooperates, by contact or by rubbing, with said braking element and stops the rotation of the arm about the rotational axis.

Said movement of the arm from said rest position to said operative position occurs when the force applied to the anchoring point of the arm exceeds a predetermined threshold. When the force ends, the arm is configured to autonomously come back to the rest position. Advantageously, the device is able to brake the rotation of the arm, reducing the risk of impacts of the user with obstacles or projections.

Even more advantageously, said device can be reused when the force which has triggered the braking system ends.

Said supporting structure can be a mast or a reticular framework.

In a first embodiment, said mast is connected at the bottom to the base and is configured to swivelling support the arm.

Said rotational stopping means can comprise a braking ring connected to the mast and configured to exercise a friction to a lateral surface of the arm when said rotational axis of the arm is inclined with respect to the vertical direction by a predetermined angle. In these conditions, said arm is in said operating position.

The braking ring is configured to exercise a friction between a fix component, for example the lateral surface of the mast, and a rotating component, for example a portion of the arm. When the inclination of the rotational axis of the arm with respect to the axis of the mast exceeds a certain threshold, the arm stops its rotation by friction against said fix component with respect to the ground.

The excessive inclination of the rotational axis can be caused by an exceeding force applied to the anchoring point of the arm, which unbalances the arm and inclines it toward the falling direction.

Said system can, in an alternative embodiment, comprise an arm having two portions swivelling connected to each other in a connection point and respectively hinged to a reticular framework. From said hinges passes the rotational axis of the arm. Said connection point can be placed to a distance from the rotational axis which is superior to the distance from the rotational axis to the centre of gravity of the arm itself.

Said reticular framework is connected at the bottom to the base and is configured to swivelling support the arm.

The base can further comprise a carriageable platform on which the wheel of a vehicle having rubber wheels can pass and stay, acting as counterweight for the device.

In this version, the arm comprises a first component and a second component, both hinged to the reticular framework by means of respective hinges.

Said first and second components are furthermore hinged each other in a connection point by means of a pin.

In this version of the device, said rotational stopping system comprises a braking element connected to the reticular framework. The second element of the braking system is a portion of the first component itself. Said portion of the arm is configured to enter in contact with said braking element when said first component rotates about the connection point. The first component of the arm can rotate with respect to the connection point when the torque generated by the falling force of the user exceeds the torque generated by the weight of the first component itself. When said first component rotates, said arm reaches said operative position.

Said connection point is positioned in an intermediate position between the centre of gravity of the first component and the anchoring point.

The safety device can further comprise one or more counterweights positioned on the base for balancing the device during its normal functioning and during the eventual fall of the operator from the work place at height.

The arm of the device can be further swivelling connected to the mast by means of a radial bearing for improving the freedom to rotate of the arm with respect to the mast.

Furthermore, the arm can be spherically hinged to the mast. Preferably. The bottom end of the vertical portion of the arm which is connected to the mast, can comprise an end which is shaped substantially as a hemi-sphere, for rolling over a planar surface located close to the top end of the mast.

When the device comprises wheels can be easily moved by a single person, because is light and in equilibrium with respect to the base. When the device has not wheels, can be easily moved by means of transpallet or forklift truck.

Once the user is in the landing platform or in the man-basket, the user is still completely safe and from there can perform certain work activities that do not require the descent of the user on the workplace at height.

Once the user has connected the worn harness to the anchoring point of the arm by means of a security lanyard, the user is free to land on the work place at height.

During the permanence on the workplace at height for inspection activities or maintenance, the user does not require to be supported or helped by other persons, because is securely connected to the anchoring point of the device.

The device so conceived is moreover economic, simply and light, because can be made with affordable materials like steel or aluminium.

These and other advantages will appear in more detail from the detailed description, in the following, of non-limiting embodiments with reference to annexed drawings.

### DRAWINGS

Now a detailed disclosure of the invention follows, made with reference to preferred embodiments, given by way of illustrative and not limiting example, and illustrated in the annexed drawings, in which:

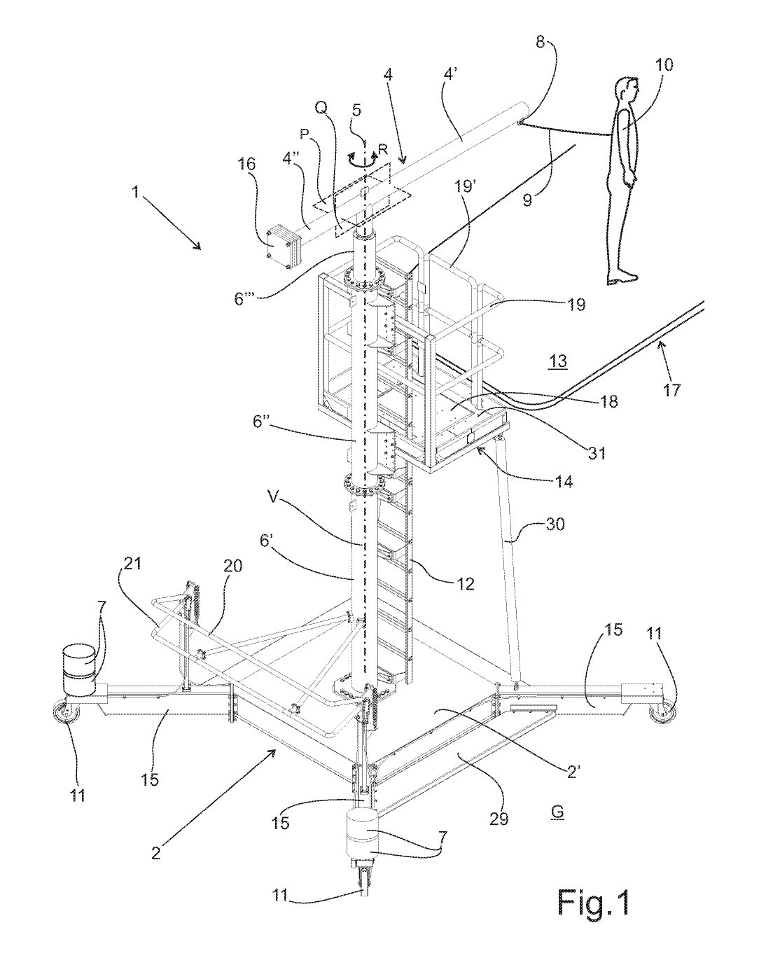

The FIG. 1 shows an axonometric view of a first embodiment of the safety device according to the present invention;

The FIG. 1 shows an axonometric view of a second embodiment of the safety device according to the present invention;

The FIG. 1 shows an lateral view of the safety device according to the present invention, wherein is shown an oblique force applied to the anchoring point and its vertical and horizontal components, shown in a schematic way;

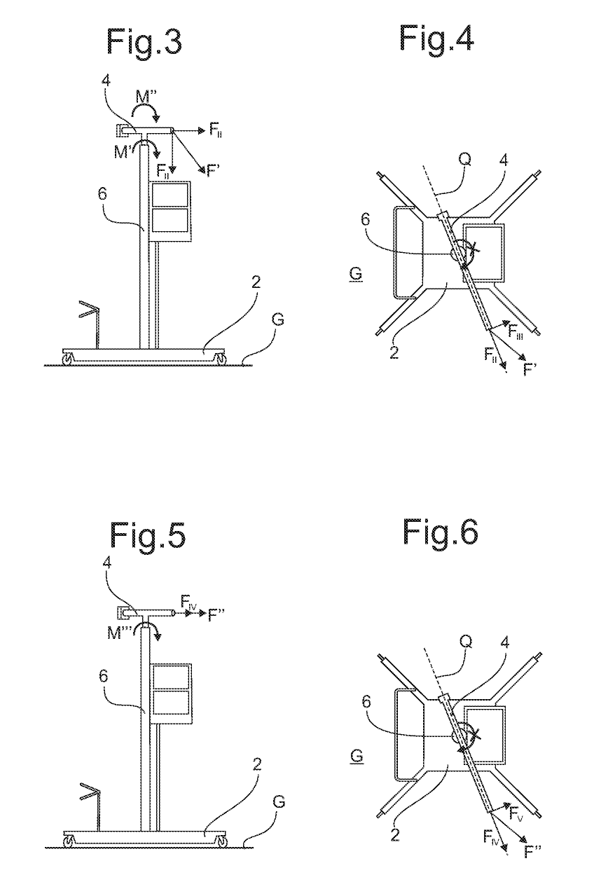

The FIG. 4 shows a top view of the safety device showed in FIG. 3;

The FIG. 5 shows a lateral view of a safety device according to the present invention wherein is shown an horizontal force applied to the anchoring point, shown in a schematic way,

The FIG. 6 shows a top view of the safety device showed in FIG. 5;

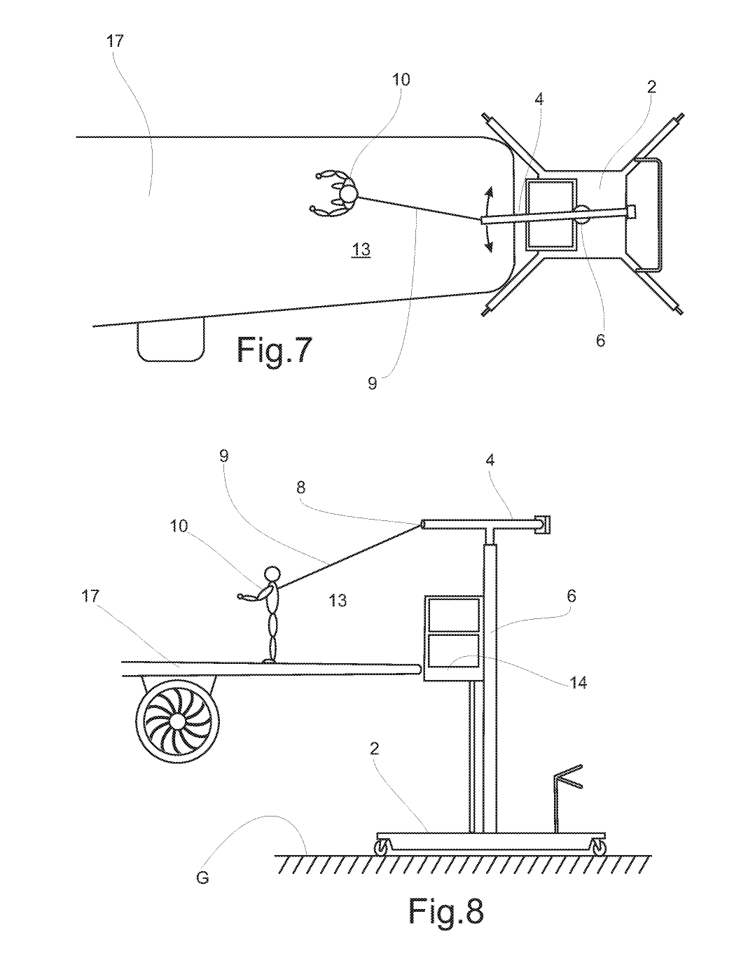

The FIG. 7 shows a top view of the first embodiment of safety device according to the present invention wherein a user working on the wing of an airplane;

The FIG. 8 shows a lateral view of the first embodiment of the safety device according to the present invention wherein a user working on the wing of an airplane;

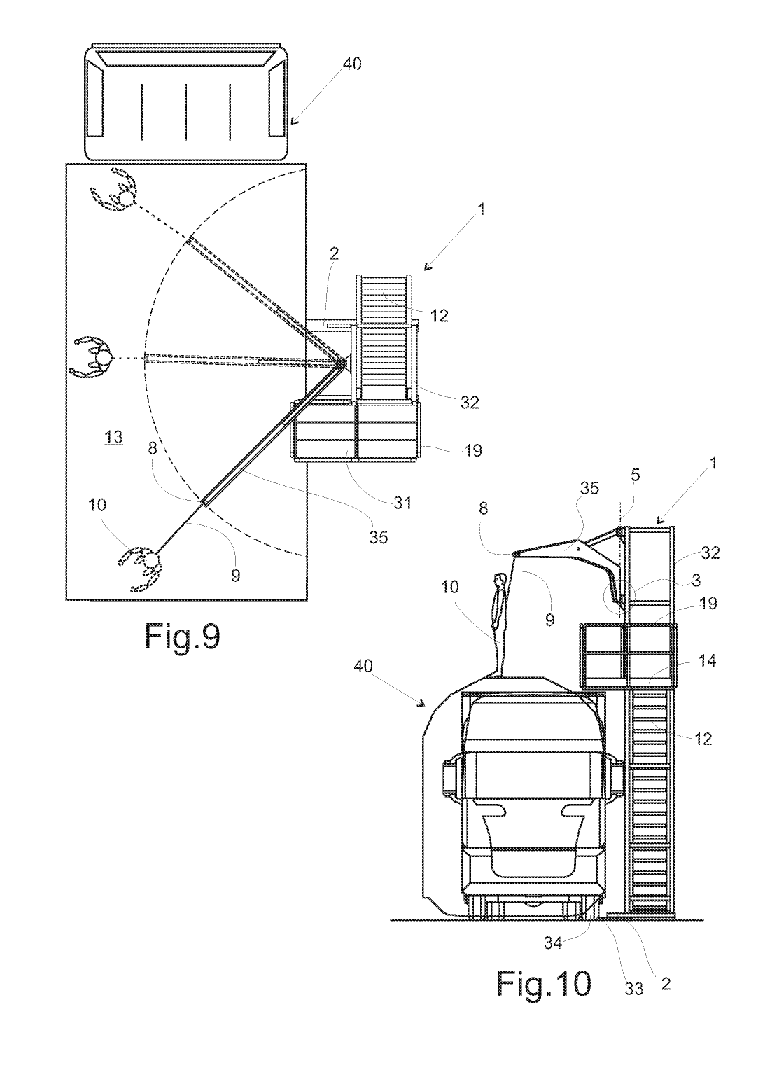

The FIG. 9 shows a top view of a second embodiment of the safety device according to the present invention with a particular emphasis to the work area on which the user can safely work during the operations at height;

The FIG. 10 shows a lateral view of a second embodiment of the safety device according to the present invention wherein a user works on the roof of a truck or train;

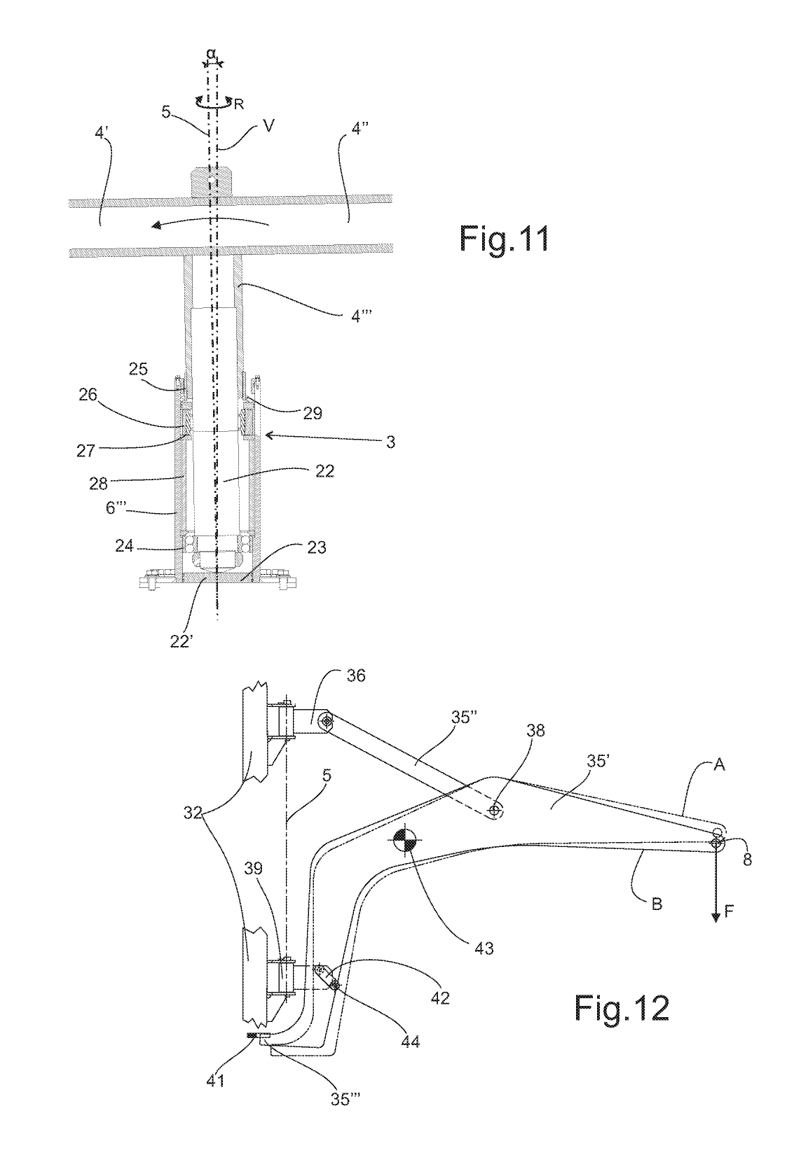

The FIG. 11 shows a detailed view of a section of a first embodiment of the rotational braking system;

The FIG. 12 shows a detailed view of a section of a second embodiment of the rotational braking system.

### DETAILED DESCRIPTION

The description and the drawings are to be considered only illustrative and thus not limiting; the present invention can be implemented according to other and different embodiments; furthermore, the drawings are schematic and exemplificative.

The same reference numbers in different drawings identify the same or similar elements. The scope of the invention is defined in the annexed claims.

With reference to FIGS. 1, 7 and 8 is shown a first embodiment of the present fall arrest safety device 1 while a user 10 is working on a wing 17 of an airplane.

Said safety device comprises a base 2, a mast 6 and an arm 4. The arm 4 comprises two cantilever horizontal portions 4′, 4″ with respect to the mast 6, each one with respective ends.

To one end is connected the anchoring point 8, while the other end is positioned a counterweight 16 for balancing the arm 4 itself. The arm 4 further comprises a vertical portion 4′″ which runs downwardly from the horizontal portion 4′,4″.

Said arm 4 is swivelling connected to the mast 6. Further details of the swivel connection and the rotation braking system are shown in FIG. 11 and in the rest of description.

The arm 4 is configured to support the weight of a person which remains hung to the anchoring point 8.

The mast 6 is substantially vertical and rigid and can comprise more portions 6′,6″,6′″ flanged to each other for allowing the assembly/disassembly and the modularization of height of the mast.

The mast 6 is connected at the bottom to a base 2, preferably by means of a flange.

A first portion 6′ of the mast 6 can have more than one length to allow a modularization of the device. The first portion 6′ has structural characteristics which are different based on its length and can be in turn made of one or more sections connected each other.

A second portion 6″ comprises flanges to which a landing platform or man-basket 14 can be connected.

The platform or basket 14 can be connected to the flanges of the second portion 6″ at different heights for providing a further adaptation of the height of the device 1 to the specific height of the work area 13. For example, three positions can be present for connecting the basket 14 (high, medium and low) to the portion 6″ of the mast 6.

The landing platform or man-basket 14 comprises a footage base 31, wherein can be provided a hatch 18 through which a man can easily pass through, and a railing 19 for avoiding the fall of the user 10.

The railing 19 can be optional, clarifying the difference between platform and man-basket.

The railing 19 can have or not a gate 19′ for accessing to the work area at height 13.

Furthermore, the platform or man-basket 14 can comprise some steps (not shown in FIG. 1) for allowing an easier descent of the user on the work area at a height 13.

To reach the platform or man-basket 14, the device 1 comprises a stair 12.

The stair 12 is connected to the mast 6 and/or to the base 2.

The stair 12 can be of different types, but preferably is a ladder.

The stair 12 can further be a caged ladder, thus comprising a protective boundary element for avoiding the user 10 falls backward.

Said stair 12 pass through the platform 14 for allowing the user 10 to easily reach the footage base 31.

The user 10 can ascent the stair 12, open the hatch 18, pass through the hatch 18, reach the height of the footage base 31, close the hatch 18 and safely stay in the basket 14.

Preferably, the stair 12 can comprise a guide (not shown) wherein a movable cart (not shown), connected to the harness of the user 10, can be arranged. This solution allows the user 10 to be firmly anchored to the stair 12 during the ascent until the platform 14 is reached.

This solution is particularly useful in case of absence of railing, thus in case of platform 14, because the user 10 is safe despite the absence of railing, until he connects his harness to the anchoring point 8 by means the security lanyard 9.

The mast 6 can be connected to the centre of the base 2 or in an eccentric way. The eccentric connection of the mast can increase the counterweighting effect of the base 2 with respect to the rest of the device 1.

The base 2 can be substantially shaped like a spider (large and flat) and comprises a central part 2′ and at least three legs 15 which extend radially. The legs 15 can be preferably four, as shown in FIG. 1.

The shape of the base 2 and its limited ground clearance, allows to easily enter below any kind of airplane or bus and consequently to approach the mast 6 to the workplace at height 13. The legs 15 are preferably flanged to a central body 2′ so that they can be substituted in case of rupture. Furthermore, the legs 15 can have various lengths for adapting the device 1 to various heights of work. For example, the device 1 having a predetermined size of the first portion 6′ and of the legs 15 can serve a workplace having a height of 3 meters. The same device 1, but having a different first portion 6′ and different legs 15, both longer and reinforces, can serve a workplace having a height of 6 meters.

Each leg 15 has a wheel 11 and/or blocking means to the ground G arranged at the opposite end with respect to the central body 2′.

The blocking means to the ground G are means configured to lock the base 2 to the ground G and can be levelling feet (not shown) of mechanical or hydrodynamic type. In this case, the levelling feet are at least two and are preferably positioned in the front part of the device 1 for guarantying a continuous anchorage to the ground G even during an eventual fall of the user 10.

Alternatively, to lock the base 2 to the ground G, the base 2 can lower, thanks to a pneumatic or hydraulic lifting system (not shown), up to touch the ground G.

The wheel 11 can comprise own blocking means for blocking the base 2 with respect to the ground G. In this case, the wheel comprises an internal system for blocking the rotation about the horizontal and vertical pins of the wheel 11.

To act the wheels 11 having the blocking means, the device 1 can comprise acting levels for operating the blocking system of the wheels 11.

In the version shown in FIG. 1, the wheels are blocked/unblocked by means of a bar 20 and a system having a functioning similar to that of airport baggage carts.

Substantially, when the bar 20 is pushed the wheels 11 are free to rotate, while when the bar 20 is released and comes back to the rest position by means of elastic means, the wheels 11 are blocked.

In this way, the user is sure that the device 1 is locked to the ground G when the bar 20 is released. In these conditions, the user 10 can move the device 1 close to the workplace and can released the bar 20 to block the device 1; a this point, the user 10 can completely safe ascent the stair 11 and reach the man-basket 14.

To obtain a complete blockage of the device 1 to the ground, two blockable wheels are enough.

The bar 20 is hinged to a rudder 21 which is firmly fixed to the base 2 and to the mast 6. Preferably, the rudder 21 is a horizontal stick configured so that an operator 10 is capable to operate alone the device 1 acting only on the stick.

The operator 10, once he has pushed the bar 20 and handled the rudder 21 can autonomously move the device 1 to and from the working area.

Alternatively to the bar 20, brake levers (not shown), like those of bicycle, can be provided on the rudder 21.

Preferably, the base can comprise, alternatively to the rudder 21 and the bar 20, a motorwheel (not shown) swivelling connected to the base 2.

Said motorwheel allows to move the device 1 by means of a command cloche (not shown). Said motorwheel is preferably powered by a battery arranged on the device 1.

The base 2 can comprise, depending on the overall dimensions and height, some counterweights arranged on the base 2, preferably on the legs 15 close to the wheels 11. These counterweights 7 increase the stability of the device 1, in particular in case of fall of the user 10, and can allow to reduce the number of legs to three or to reduce the length of the frontal legs. In the version having three legs of the device, the legs are not arranged like those of FIG. 1, but they are rotated of 45° with respect to those and the leg which cantilevers on the basket side is absent.

The counterweights can be disks or rings of cement or metal having a predetermined weight, for example 10 or 20 kg each one, and they can be stacked each other on the base 2.

Alternatively, some tanks can be arranged on the base 2 to work as counterweights 7. In an alternative version of the device 1, the counterweights are configured to be firmly connected to the mast 6.

The base 2 can comprise some access steps 29 on the base 2 from which the user 10 can access to the stair 12.

The arm 4 can be substantially “T” shaped, or alternatively, can be shaped as reversed “L” or “I”.

The horizontal portions 4′, 4″ of the arm 4 extends in opposite directions with respect to the mast 6.

The portion 4′ comprises at one end the anchoring point 8, while the opposite portion 4″ comprises at its end a balancing counterweight 16.

The vertical portion 4′″ of the arm 4 can have an external diameter which is minor of the inner diameter of the terminal portion 6′″ of the mast 6, for allowing the insertion of the vertical portion 4′″ in the terminal portion 6′″.

The terminal portion 6′″ of the mast 6 is connected to the portion 6″ by means of a flange.

In FIG. 11 is shown a first version of the braking system 3, together with a portion of the arm 4 and a portion of the mast 6, when this arm 4 is in said operating position B.

The terminal element 6′″ of the mast 6 comprises a flat element 23 arranged on the top, on which lies the hemispherical end 22′ of the pivot element 22 which is part of the vertical portion 4′″ of the arm 4.

The pivot element 22 is mechanically connected to the arm 4 and rotates, together with it, about the rotational axis 5.

Since the arm 4 can pivot with respect to the mast 6 and so with respect to the ground G, the rotational axis 5 can tilt with respect to the vertical direction V exiting from the ground G by an angle comprised between zero and a predetermined angle α.

The vertical V to the ground G normally coincides with the mast axis because the base is parallel to the ground G and mast 6 is perpendicular to the base 2.

Preferably, it possible to fine levelling the base 2 of the device 1 by means of a planar levelling system comprising a plurality of levels, so that the base 2 becomes parallel to the ground G.

When the angle between the rotational axis 5 and the vertical V to the ground G, thus the mast axis, reaches a predetermined value a, the vertical portion 4′″ of the arm 4 touches the braking ring 25, which is firmly connected to the terminal element 6′ of the mast 6, and brakes the rotation R.

The braking element 25 can have different shapes and can be made of different materials, provided that it is configured to exercise a strong friction or interference between the portion 4′ of the arm 4 and the terminal element 6′ of the mast 6.

The interference or friction ensured between the arm 4 and the mast 6 allows to quickly stop the rotation of the arm 4 itself.

Preferably the braking ring 25 can be a ring having an inner surface with a high superficial roughness. Alternatively, the braking ring 25 can be a gear having inner teeth and configured to interact with other teeth of the terminal element 6′″ of the mast 6.

If the mast 6 and the arm 4 comprise teethed surfaces configured to interact each other, the rotational brake of the arm 4 happens fast.

While, in case of a surface having a high roughness, the brake of the rotation of the arm 4 is gradual, because of the friction of the surfaces of the arm 4 and the mast 6. In this case, the pendulum effect deriving by the fall of the user 10 is mitigated.

The braking ring 25 can be arranged internally to the terminal element 6′″ of the mast 6, as shown in the FIG. 11, or alternatively, can be arranged externally to the element 6′″. In the latter case, the braking element 25 faces toward the surface of the arm 4 (not shown) configured to cooperate with the braking element 25 when the contact occurs. In this case, the maintenance of the elements is facilitated because they are both arranged externally.

A bushing 27, supported radially by an elastic ring 26, is interposed between the pivot element 22 of the terminal element 6′″ of the mast 6 and the braking ring 25, for avoiding that the portion 4′″ of the arm 4 continuously makes contact with the braking ring 25 during the rotation of the arm 4.

Being the ring 26 elastic, when a force is applied to the anchoring point 8, the rotational axis 5 tilts with respect to the vertical direction, and the pivot element 22 compresses the elastic ring 26 through the bushing 27.

The elastic ring 26 is configured to reversibly deform itself when a torque generated by the force F applied to the anchoring point 8 exceeds a predetermined threshold. Said torque tends to incline the rotational axis 5 about the point of contact of the hemispherical end 22′ with the flat element 23. Varying the intensity of the force F, and in particular of the component lying on the plane Q passing through the rotational axis 5, the elastic element 26 is compressed under the action of the pivot element 22 on the bushing 27, because the inclination of the rotational axis 5 of the arm 4 is changing.

The end 22′ is hemispherical so to reduce the rolling resistance between the pivot element 22 and the flat element 23. Alternatively, the arm 4, in particular its vertical portion 4′″, can be spherically hinged to mast 6.

A radial bearing 24 allows to swivelling connect the lower part of the pivot element 22 of the arm 4 to the mast 6, in particular to its terminal element 6′″.

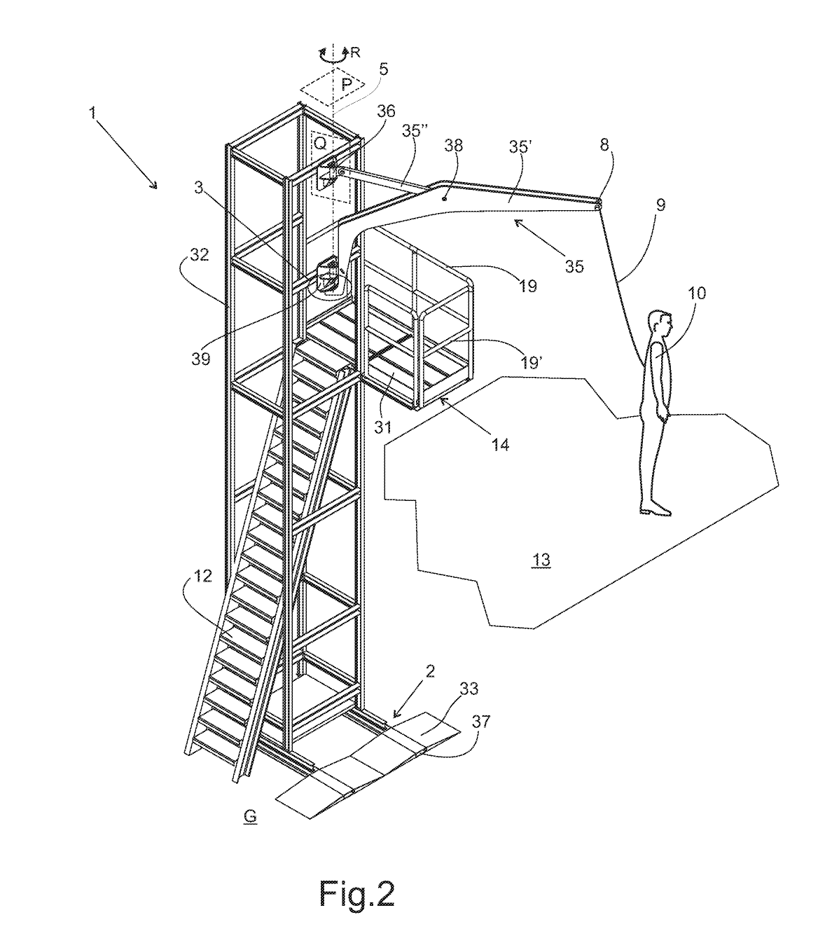

Here-below is described a second embodiment of the device 1, with particular reference to the FIGS. 2, 9 and 10.

As shown in FIG. 2, the device 1 comprises a base 2 connected to a supporting structure. The base 2 can comprise a carriageable platform 33 on which a wheel 34 of a vehicle having rubber wheels can pass and stay. Said carriageable platform comprises a pair of ramps arranged consecutively to allow the ascending and descending of the vehicle wheel 34 and the stop of the wheel in a intermediate position.

Said base 2 is configured so that can be partially arrangeable under a train. In particular, said carriageable platform 33 cantilevers from the side wherein the device 1 is used so that the platform does not impact with the rail tracks when the device 1 is close to the train. Thanks to fact that the base 2 is partially arrangeable under the vehicle (train, bus, etc.), the device 1 can approach the vehicle 40, facilitating the access to the working zone at a height 13, as shown in FIG. 10.

The base can comprise one or more slots 37 configured to receive the forks of a transpallet or forklift truck. These slots 37 allow an easy transportation of the device 1.

The base 2 can comprise blocking means to block the base 2 to the ground G once the work area is reached.

The supporting structure of this embodiment comprises a reticular framework 32 having a parallelepiped shape, as shown in FIG. 2.

Internally to the reticular framework 32 can be housed a stair 12.

Said stair 12 allows the access to the landing platform 14 and comprises steps.

Said platform 14 comprises a railing 19, a gate 19′ and footage base 31 like those of the first embodiment.

Said reticular framework 32 comprises a plurality of vertical and horizontal elements connected each other to form the supporting structure of the device 1.

Preferably the reticular framework 32 comprises beams having a “H” profile.

A top portion of the reticular framework 32, opposed to that connected to the base 2, comprises two hinges 36, 39 to which the arm 35 is swivelling connected.

The arm 35 of this embodiment comprises a first component identified with the reference 35′. Said first component 35′ is ark-shaped to avoid contacts with the head of the user standing on the platform 14 during the rotation of the arm 35.

Said arm 35 further comprises a second component identified with the reference 35″. With particular reference to FIG. 12, said components 35′, 35″ are respectively hinged to the hinges 36, 39 and can rotate respect the rotational axis 5. Said components 35′, 35″ are also swivelling connected each other in a point 38, for example by means of a pin.

Said connection point 38 is positioned in a intermediate position between the centre of gravity 43 of the first component 35′ and the anchoring point 8

This particular arrangement of the connection point 38 allows a rotation of the first component 35′ of the arm 35 about the connection point 38 if a torque is applied. The relative position of the connection point 38 with respect to the centre of gravity 43 of the first component 35′ and with respect to the anchoring point 8, allows to determine the arm of the torques generated by the weight-force of the first component 35′ and generated by the force caused by the fall of the user 10.

Said first component 35′ can comprise a guide 42 in which a pin 44 connected to the hinge 39 is free to move between two end of stroke positions.

When this force F having a predetermined intensity is applied to the anchoring point 8, a new torque is generated, opposed to that generated by the weight of the first component 35′. If the intensity of this new torque exceeds the intensity of that generated by the weight of the first component 35′, the latter rotates and the pin 44 moves in the guide 42 up to the second end of stroke position.

The first component 35′ comprises a portion 35′″ which enters in contact with said braking element 41, thus stopping the rotation of the arm 35, when said arm is in said operating position.

Said braking element can be made of a plastic material able to plastically deform itself in case of collision with said portion 35′″ or a toothed surface able to receive portion 35′″. Any other solution operatively equivalent to those described can be used.

When the force F ends, the weight of the first component 35′ rotates the arm 35 in said rest position and said device 1 can be used again.

The end of the arm 35 opposite to the reticular framework 32 comprises an anchoring point 8 to which, like in the first embodiment of the device, the security lanyard 9 can be connected, with or without the auto-wrapping device.

The security lanyard 9 is furthermore connected to the harness worn by the user 10. In this embodiment, the anchoring point 8 can be a pin connected to the first component 35′ of the arm 35.

Like in the previous embodiment, the user 10 can easily connect himself to the device 1 when he is standing on the platform 14 so that he is not exposed to risks of fall.

All the technical characteristics described for the first embodiment of the device 1 are also applicable to the second embodiment if compatible.

The following description is applicable, unless otherwise indicated, to both embodiments. For example, in the FIGS. 3, 4, 5 and 6 is shown the device 1 according to the first embodiment, but the same concepts are also applicable to the second embodiment and its arm 35.

The device is able to react to vertical or horizontal forces applied to the anchoring point 8. Consequently, if the user accidentally falls from the work area, the security lanyard 9 tightens up and a force F is applied to the anchoring point 8. The force F triggers an interruption of the arm rotation by means of the braking system 3 as shown in the FIGS. 4 and 6.

The braking system 3 is conceived so to react to forces that can be exclusively horizontal or exclusively vertical, as long as the forces F have at least a component (F_{I} F_{II} in FIGS. 3 and 4 and F_{IV} in FIGS. 5 and 6) lying on the plane Q passing through the rotational axis 5.

Even when the force F has an upward vertical component, for example if the user 10 climbs a structure and falls on the opposite side of the structure, the device is able to react stopping the rotation of the arm 4 and blocking the fall point (the anchoring point 8) with respect to the ground G.

In FIGS. 3 and 4 is shown the more common situation, wherein the force F′ has three components: F_{I} lying on the plane Q and vertically oriented, F_{II} lying on the plane Q and parallel to the ground G, F_{III} orthogonal to the plane Q and parallel to the ground G. The component F_{I} causes a torque M′ that inclines the arm 4. The component F_{II} causes a torque M″ that inclines the arm 4. The component F_{III} allows the rotation of the arm 4 about the axis 5.

If the components exceeds a predetermined threshold, the braking system 3 is triggered and the rotation of the arm is stopped.

In the first embodiment, the vertical portion 4′″ of the arm 4 contacts the braking ring 25, because of the inclination of the arm 4 caused by the momentary forces M′ and/or M″. In this case, the arm 4, rotated by the force F_{III}, is stopped.

In the second embodiment, the first component 35′ rotates about the connection point 38 and contacts the braking element 41. In this case, the arm 35, rotated by the force F_{III}, interrupts its rotation.

In the FIGS. 5 and 6 is shown the further situation, wherein a force F″ applied to the anchoring point 8 comprises two components: a first component F_{IV} lying on the plane Q, and a second component F_{V} orthogonal to the plane Q. Both components F_{IV} and F_{V} are parallel to the ground G, thus horizontally oriented.

The component F_{IV} is a traction component of the arm 4 and triggers the torque M′″ that inclines the arm 4. The component F_{V} rotes the arm 4 about the axis 5.

If the component F_{IV} exceeds a predetermined threshold, the rotational stopping means 3 are triggered and the rotation of the arm is stopped.

In the first embodiment, the vertical portion 4′″ of the arm 4 contacts the braking ring 25 for the inclination of the arm 4 caused by the torque M′″. In this case, the arm 4, which is rotating for the force F_{V}, interrupts its rotation.

In the second embodiment, the first component of the arm 35′ rotates about the connection point 38 and contacts the braking element 41. In this case, the arm 35, rotated by the force F_{V}, stops its rotation.

In the first embodiment, to trigger the braking system 3 and so to interrupt the rotation of the arm 4 with respect to the base 2, the intensity of said component lying on the plane Q needs to exceed the elastic resistance of the elastic ring 26. Consequently, said intensity is function of the elastic characteristics of the element supporting the bushing 27, thus of the elastic element 26.

In the second embodiment, in order to trigger the rotational stopping means 3, the intensity of the component lying on the plane Q of the force applied to the anchoring point 8, needs to exceed a predetermined threshold. Said threshold is proportional to the ratio between the arm of the torque generated by the weight of the first component 35′ of the arm 35 about the connection point 38 and the arm of the torque generated by the force F applied to the anchoring point 8.

The device 1 is configured to react when the component of the force F is less 500 N, preferably less than 300 N, even more preferably less than 200 N.

The device 1 so conceived is able to resume its initial state, once the force F goes below the intensity suitable to trigger the braking system 3.

Substantially, the elasticity of the elastic ring 26 allows to realign the rotational axis 5 of the vertical portion 4′″ of the arm 4 to the vertical direction V and so to discharge the braking system 3.

In the second embodiment, the weight of the first component 35′ of the arm 35 is able to bring back the first component in its rest position.

The device 1 so conceived is reversible: following a determined force which has caused the stop of the rotation of the arm 4,35, the system is able to come back to its original condition if said predetermined force ends. The device can be used continuously and can resist to numberless falls of the user 10.

In order to monitor if a user 10 fell from the device 1, the latter can comprise an element adapted to register the occurred fall. For example, the braking element 41 can be made of a plastically deformable material, so that it's possible to check if a fall occurs. Alternatively, said second component 35″ of the arm 35 can comprise an element adapted to be deformed for elongation if the element is subjected to a traction exceeding a determined threshold. The elastic ring 26 shall be periodically checked and, eventually, substituted when ordinary maintenance sessions occur.

The device 1 so conceived can be used in any place and without the need for electricity because is merely constituted by mechanical components.

The arm 4 of the device 1 according to the first embodiment can rotate of 360° on the plane P, even if it preferably rotates of +/−90° with respect to the landing platform or man-basket 14. The second embodiment of the device is configured to rotate of a maximum angle of 180°. The plane P is substantially parallel to the ground G and is distant at least 2 meters from it, preferably at least 4 meters.

This device is particularly useful for inspection, assembling or maintenance activities of machines having heights higher than 2 meters, for example airplanes, trains, helicopters, trucks, busses, and boats.

The device 1 can furthermore comprise padded chains 30, connected to the platform and to the base 2, to avoid collisions of the mast 6 or the stair 12 with cantilevered elements like, for example, the fuselage of an airplane or the side of a train.

In a particular version, the anchoring point can be arranged on movable carriage (not shown) linearly connected to the horizontal portion 4′ of the arm 4, so that it can vary its position along the portion 4′.

In an alternative version of the device (not shown), the arm can comprise only a horizontal portion and the top end of the mast is directly hinged with said arm. In this case, the arm includes braking means similar to those described above.

In a alternative version of the device (not shown), the vertical portion of the arm is directly connected to the base without mast. In this case, the platform or basket are directly connected to the vertical portion of the arm and rotate together.

The device so conceived has an minimal encumbrance and consequently can be used contemporary with other similar devices on the same working area. For example, in case of a big airplane, more devices can cooperate on the same airplane in different zones, avoiding collisions and without decreasing the safety of the users.

The security lanyard 9 can be a cable having a fix length. Alternatively, the security lanyard 9 can comprise a auto-wrapping system which allows the extension of the cable until a certain length is reached, if the traction force applied is less than a predetermined intensity; and is able to block itself, when the traction force exceeds said predetermined intensity, like it occurs on the braking system of the safety belts of vehicles.

Alternatively, the security lanyard 9 can have a fix length and comprise a squanderer at one end. A squanderer is a shock attenuation system, for example a spring, for absorbing at least in part eventual extra-loads on the lanyard 9 and for reducing the probability of injury for the user 10 due to abrupt and strong arrests.

An end of the security lanyard 9 can be connected to the anchoring point 8 of the device 1, while the opposite end is connected to the harness worn by the user 10.

The security lanyard 9 is configured and selected so that, in case of fall, the user does not impact with ground G. The maximum extension of the security lanyard 9 is thus selected as a function of the height of the anchoring point 8 and of other factors as: the height of the user 10, the selected security margin and the work area on which the user 10 needs to work.

The device 1 can optionally comprise also an alarm system (not shown) connected to the end of the security lanyard 9 connected to the user 10. By means of said alarm system, the user 10 can sound an alarm in case of a fall. Thanks to the acoustic signal, the user 10 can attract the attention and obtain the required support for disengaging him from the security cable 9 and go back to land. Said alarm system can be acted manually or automatically.

The device 1 so conceived is extremely easy to be assembled and disassembled. Once the device is disassembled it can be transported with vehicles of small dimensions or, in case of a device conceived for airplanes, in the airplane itself.

To understand the idea underlying the present invention, can be made reference to FIGS. 7, 8, 9 and 10.

In particular, FIG. 9 shows a device 1 in three different positions, represented with dotted lines.

Being the base 2 firmly anchored to the ground, the arm 35 can rotate respect the base. The user 10, moving on the work area 13, can drag in rotation the arm 35, as shown in FIGS. 7 and 8.

As previously described, the device 1 is in equilibrium and unload the forces on the ground G. The arm 4, 35 is thus free to rotate about the rotational axis 5. The user can rotate the arm 4, 35 without resistance.

Rotating the arm 4, 35 the user 10 has a wider range of action with respect to the known systems and can cover a very wide area (see FIG. 9).

In the area of action of the device, the user 10 is continuously safe, because of the structure follows his movements and is always collocated in an optimal point for supporting the user 10 in case of fall.

In case of a fall, the user 10 is secured and cannot impact the ground G.

The movement of the arm 4, 35 guarantees always the minimal distance between the support of the device 1 and the user 10.

Here-below are finally described some particular further advantageous embodiments:

Safety device comprising a counterweight arranged on the base.

Safety device wherein the arm is swiveling connected to the mast by means of a radial bearing.

Safety device wherein the arm is connected or spherically hinged to the mast.

Safety device wherein the rotational stopping means comprise means configured to exercise a friction on the arm when said rotational axis of the arm is tilted with respect to the mast axis of a predetermined angle α.

Safety device wherein said rotational stopping means comprises two toothed surfaces arranged respectively on the arm 4 and on the mast 6 and configured to interact each other in case of friction, stopping the relative sliding of a surface on the other.

1. Safety device comprising:
a base positionable on the ground;
a supporting structure configured to swivelling support an arm rotatable about a rotational axis;
rotational stopping means comprising elements connected respectively to the arm and to the supporting structure configured to cooperate each other to interrupt the rotation of the arm about the rotational axis when the intensity of a component lying on a plane passing through the rotational axis of a force applied to an anchoring point of the arm exceeds a predetermined threshold.

2. Safety device according to claim 1, wherein said base comprises blocking means configured to stop the base to the ground.

3. Safety device according to claim 1, wherein said anchoring point is arranged at least 2 meters from the ground, preferably at least 4 meters from the ground.

4. Safety device according to claim 1, wherein said anchoring point is rigidly connected to the arm near its farthest end from the rotational axis.

5. Safety device according claim 1, wherein said force applied to an anchoring point is a force generated by the fall of a person from a workplace at height, being that person connected to the anchoring point by means of a security lanyard.

6. Safety device according to claim 1, wherein said predetermined threshold of the intensity of the component of said force being less than 500 N, preferably less than 300 N.

7. Safety device according to claim 1, wherein said supporting structure comprises a landing platform or man-basket and a stair to access to landing platform or man-basket.

8. Safety device according to claim 1, wherein said arm is movable between a resting position and an operating position when the force applied to the anchoring point exceeds said predetermined threshold.

9. Safety device according to claim 1, wherein said elements of the rotational stopping means are a braking element and a portion of the arm, wherein said portion of the arm comes into contact with said braking element connected to said arm when said arm is in said operating position.

10. Safety device according to claim 1, wherein said supporting structure comprises a mast connected at its bottom to the base and configured to swivelling support the arm.

11. Safety device according to claim 10, wherein said rotational stopping means comprises a braking ring connected to the mast and configured to act a friction on a lateral surface of the arm when said rotational axis of the arm is inclined with respect to the vertical direction by a predetermined angle, being the arm in said operating position.

12. Safety device according to claim 1, wherein said supporting structure comprises a reticular framework connected at its bottom to the base and configured to swivelling support the arm.

13. Safety device according to claim 12, wherein the base comprises a carriageable platform.

14. Safety device according to claim 12 or 13, wherein the arm comprises a first component and a second component hinged to the reticular framework by means of respective hinges and swivelling connected each other in a connection point.

15. Safety device according to claim 14, wherein said rotation stopping means comprises a braking element connected to the reticular framework, said first component of the arm comprises a portion configured to comes into contact with said braking element when said first component rotates about a connection point, being said arm in said operating position.

16. Safety device according to claim 14 or 15, wherein the connection point is arranged in an intermediate position between the centre of gravity of the first component and the anchoring point.
